(19) United States
(12) Patent Application Publication
(10) Pub. No.: US 2010/0076353 A1
(43) Pub. Date: Mar. 25, 2010

(54) Roller therapy apparatus

(76) Inventor: Gary Lawrence Johnston, Cowarts, AL (US)

Correspondence Address: Gary Lawrence Johnston, 181 Crimson Road, P.O. Box 183, Cowarts, AL, 36321, US

(21) Appl. No.: 12/284,376

(22) Filed: Sep. 22, 2008

(51) Int. Cl. A61H 15/00

(52) U.S. Cl. 601/24

(57) ABSTRACT

A roller therapy apparatus is provided which enables the user to engage a spherical shaped roller element with various body muscle groups. The apparatus includes a frame structure means, a roller engagement means, and a roller structure means. The frame structure means comprises a base frame structure with a user support member mounted thereon and having an opening. The roller structure means comprises a base roller structure with a roller support member rigidly mounted thereon. The base roller structure mounts to the base frame structure of the frame structure means, while the roller support member rotatably receives and supports the spherical roller element of the roller engagement means. The roller structure means is mounted to said frame structure means such that at least a portion of the spherical roller element extends through the opening of the user support means, above its top surface. The user operates the apparatus by positioning themselves upon the user support member and engaging with various muscle groups the portion of the spherical roller element which extends above the top surface. The spherical roller element will exert a force or pressure against the muscle group which is pressed against it. The roller structure means may be adjusted and secure at different intervals along the base frame structure of the frame structure means so that the elevation of the portion of the spherical roller element which is extended above the surface of the user support member may be varied. The frame structure means may also have a collapseable feature so that the apparatus may be more easily stored and transported. A wheel assembly may also be included to assist in storage and transport.

### BACKGROUND OF THE INVENTION

This invention relates to a roller therapy apparatus which has a generally horizontal user support structure with a roller element supported by the structure that allows the user to perform therapy routines on upper and lower body muscle areas. These routines are performed while in a relatively relaxed position. The ability to engage the muscles of the user with a roller element which rolls against the muscles allows for an easy and comfortable message type therapy for muscle groups which are sore or have been traumatized due to an accident or illness.

### SUMMARY AND OBJECTS OF THE INVENTION

It is the object of this invention to provide a theraputic apparatus which may provide the user an efficient and inexpensive means for messaging upper and lower body muscle groups. The main purpose of this application is to demonstrate an apparatus which performs the stated function, and to demonstrate the many options and configurations this apparatus may take on.

Briefly stated, the apparatus that forms the basis of the present invention comprises a frame structure means, a roller structure means, and a roller engagement means. The roller structure means is mounted upon the frame structure means, while the roller engagement means is supported by the roller structure means. The user will place themselves upon the frame structure means and engage the roller engagement means with a muscle group. Also, optional features of the apparatus which make the apparatus more flexible are an adjustable roller structure means and a collapseable frame structure means.

The design of the apparatus is such that the roller engagement means is rotatably support by the roller structure means so that the roller engagement means may rotate in any direction. Also, the frame structure means has a relatively horizontal user support member for supporting the user. The user support member has an opening through which the roller engagement means extends to a level which is above the top surface of the user support means. Thus the user is able to engage the roller engagement means with various muscles of the body while being supported by the user support means. The roller engagement means will produce force or pressure against those muscles groups which are engaging the roller engagement means. This force or pressure should provide relief from soreness, aches, and pains which are located in the engaged muscle group. In addition to providing a type of theraputic exercise, the apparatus will assist with the removal of fat tissues and cellulite from affected body areas.

### BRIEF DESCRIPTION OF THE DRAWINGS

FIG. 1A is a front view of the roller therapy apparatus.

FIG. 1B is a side view of the roller therapy apparatus.

FIG. 1C is a top view of the roller therapy apparatus.

FIG. 2A is a front view of the frame structure means of the roller therapy apparatus.

FIG. 2B is a side view of the frame structure means of the roller therapy apparatus.

FIG. 2C is a top view of the frame structure means of the roller therapy apparatus.

FIG. 3A is a front view of the roller structure means of the roller therapy apparatus.

FIG. 3B is a side view of the roller structure means of the roller therapy apparatus.

FIG. 3C is a top view of the roller structure means of the roller therapy apparatus.

FIG. 4A is a front view of the roller engagement means of the roller therapy apparatus.

FIG. 4B is a side view of the roller engagement means of the roller therapy apparatus.

FIG. 4C is a top view of the roller engagment means of the roller therapy apparatus.

FIG. 5A is a front view of the roller therapy apparatus showing how the roller engagment means may rotate about a first axis of rotation.

FIG. 5B is a side view of the roller therapy apparatus showing how the roller engagment means may rotate about a second axis of rotation.

FIG. 5C is a top view of the roller therapy apparatus showing how the roller engagment means may rotate about a third axis of rotation.

FIGS. 6A, 6B, and 6C are side views of the roller therapy apparatus, demonstrating an adjustable roller structure means which allows the roller engagment means to be positioned at various elevations.

FIGS. 7A and 7B are side and top views respectfully of the roller structure means having bearing elements for making movement of the roller engagement means smoother.

FIGS. 8A and 8B are front views of the roller therapy apparatus having a collapseable frame structure means, along with wheel elements, which makes for easy transport and storage of the apparatus.

### DETAILED DESCRIPTION OF THE PREFERRED EMBODIMENT

Before explaining in detail the present invention, it is to be understood that the invention is not limited in its application to the details of construction or arrangement of parts illustrated in the accompanying drawings, since the invention is capable of other embodiments and of being practiced or carried out in various ways. Also, it is to be understood that the phraseology and terminology employed herein is for the purpose of description, and not limitation.

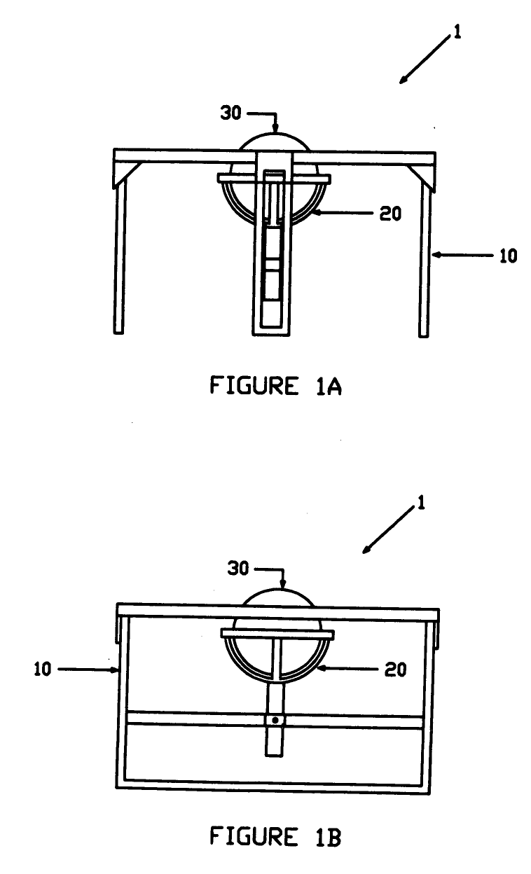

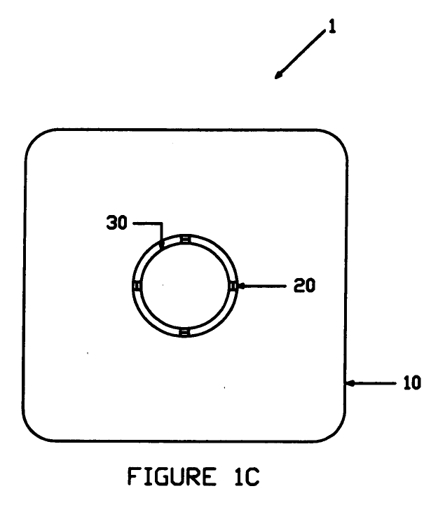

As best can be seen by references to the drawings, and in particular to FIGS. 1A-1C, the roller therapy apparatus that forms the basis of the present invention is designated generally by the reference numeral 1, and includes a frame structure means 10, a roller structure means 20, and a roller engagement means 30. The roller structure means 20 is mounted on the frame structure means 10, while the roller engagment means 30 is rotatably supported by the roller structure means 20.

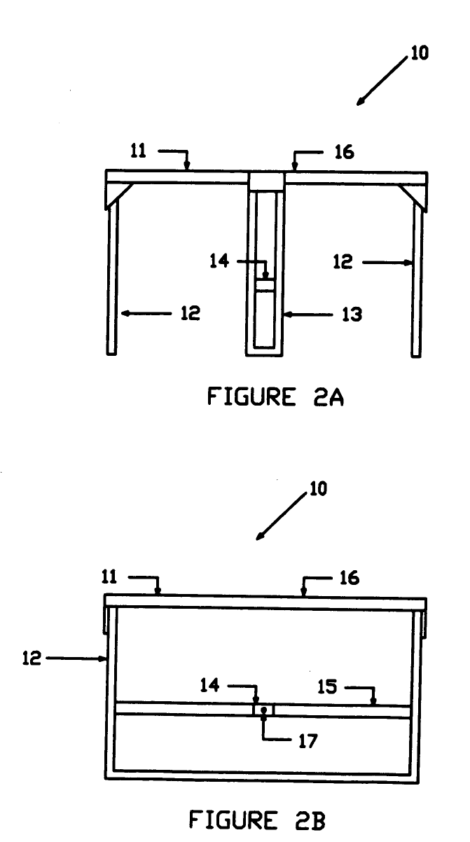

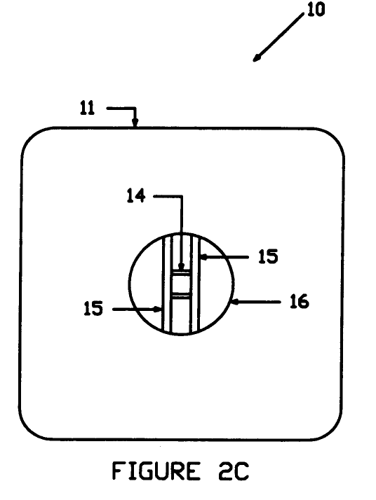

As may be seen in FIGS. 2A-2C, the frame structure means 10 comprises a user support member 11, side support members 12, main support members 13, roller structure support member 14, cross support members 15, roller opening 16, and frame attachment opening 17. The user support member 11 is a relatively horizontal surface, preferrably padded, supported along its sides by side support members 12, and along its front and rear by main support members 13. Cross support members 15 connect the front and rear main support members 13, and also supports roller structure support member 14. Roller structure support member 14 is mounted to cross support members 15 directly below roller opening 16, and has a frame attachment opening 17. Roller opening 16 is a generally round opening in the general center of user support member 11.

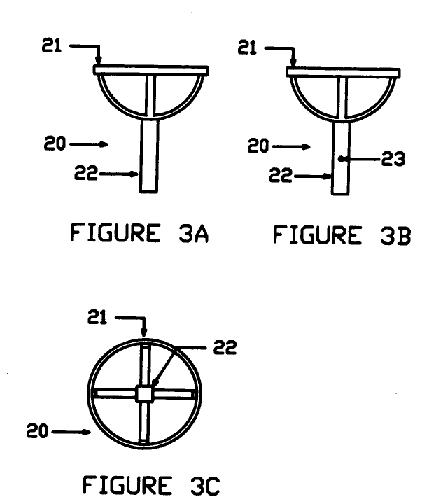

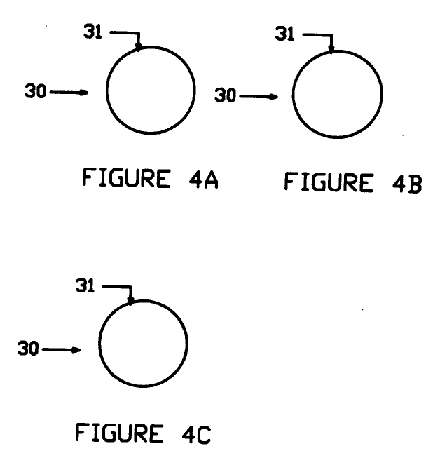

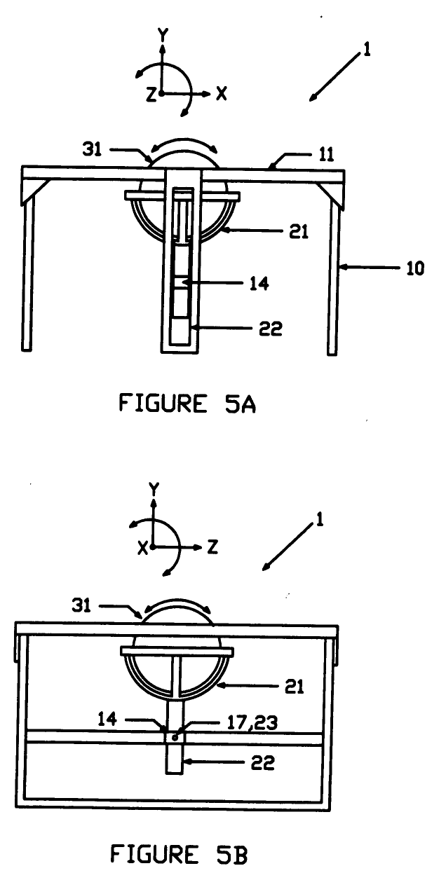

As may be seen in FIGS. 3A-4C, roller structure means 20 comprises a generally upright main roller structure member 22 with roller support member 21 rigidly mounted thereon. Roller engagment means 30 is comprised of a spherical roller element 31 which is a spherical shaped object having a smooth surface. Roller support member 21 is sized to rotatably receive spherical roller element 31. Roller structure member 22 has a main roller structure opening 23 which is used for mounting the member to frame attachment opening 17 of frame structure means 10.

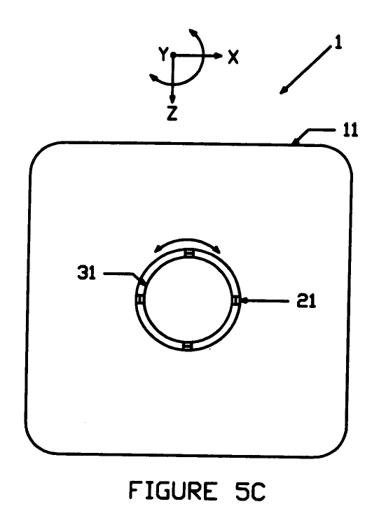

The basic operation of roller therapy apparatus 1 may be seen in FIGS. 5A-5C. As shown, the main roller structure member 22 of roller structure means 20 fits within roller structure support member 14 of frame structure means 10. Frame attachment opening 17 and main roller structure opening 23 are aligned so that a bolt or pin may be used to secure the two together. As may also be seen, spherical roller element 31 is rotatably supported by roller support member 21, such that spherical roller element 31 may rotate about the X, Y, and Z axes, either one at a time or simultaneous. As may also be seen, a portion of spherical roller element 31 extends above the top surface of the user support member 11 of frame structure means 10. The portion of spherical roller element 31 which extends above user support member 11 is the part which is engaged by the user. The user may lay or sit on user support member 11 and engage spherical roller element 31 with any desired muscle group. Since the roller engagment means 31 is free to rotate in any direction, the user may engage it from any direction, and thus apply a force or pressure to the desired muscle groups from any direction. This ability makes the apparatus extremely flexible and and thus very useful.

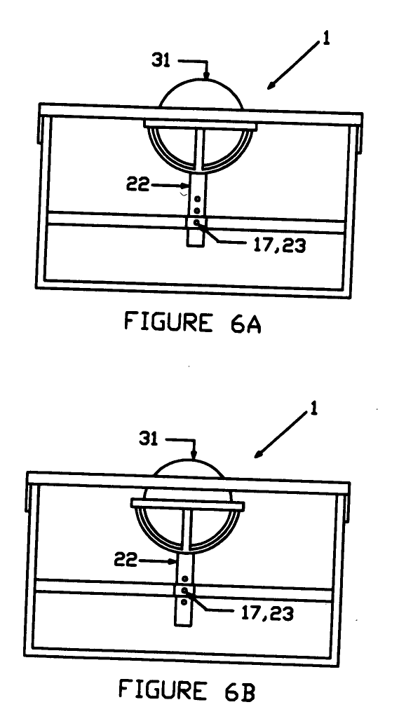

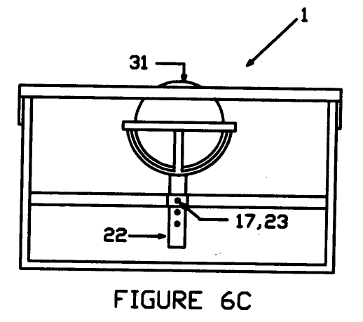

FIGS. 6A-6C demonstrate roller therapy apparatus 1 having an adjustment feature. The main roller structure member 22 may have several main roller structure openings 23, any of which may be aligned with frame attachment opening 17 and secured via a bolt or pin. Since the main roller structure openings 23 are at different elevations, a portion of spherical roller element 31 may thus be secured at levels above the top surface of user support member 11. This feature allows the user to vary the direction and the amount of the force or pressure exerted by spherical roller element 31 on the desired muscle group. As example, with spherical roller element 31 is in the position shown in FIG. 6A, the user may sit on the user support member 11, and engage spherical roller element 31 with thigh and calf muscle groups. When the spherical roller element 31 is in the position shown in FIG. 6B, the user may lay upon the user support member 11 either face down or on their side, and engage spherical roller element 31 with abdominal muscle groups. When the spherical roller element 31 is in the position shown in FIG. 6C, the user may lay upon the user support member 11 either face up or on their side, and engage spherical roller element 31 with back and neck muscle groups. The force or pressure exerted by spherical roller element 31 on the respective muscle group will create a theraputic form of exercise, similar to a message, providing relief from soreness, aches, and pains. These are only examples, and any muscle group may engage the spherical roller element 31 while it is in any position. Also, engaging spherical roller element 31 with the abdominal and thigh muscle groups should assist with the breakdown and removal of fat tissue and cellulite.

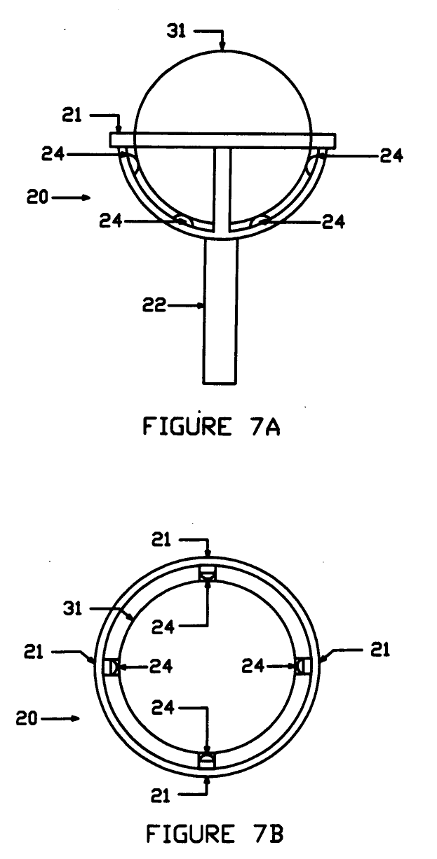

FIGS. 7A and 7B demonstrate a roller structure means 20 which utilizes bearings to make rotation of spherical roller element 31 smoother. As may be seen, bearing elements 24, which may be a type of roller or slider bearings, may be mounted to the roller support member 21 of roller structure means 20 at various positions. Thus when spherical roller element 31 moves against bearing elements 24, instead of directly against roller support member 21, the amount of friction is reduced, making movement smoother and easier.

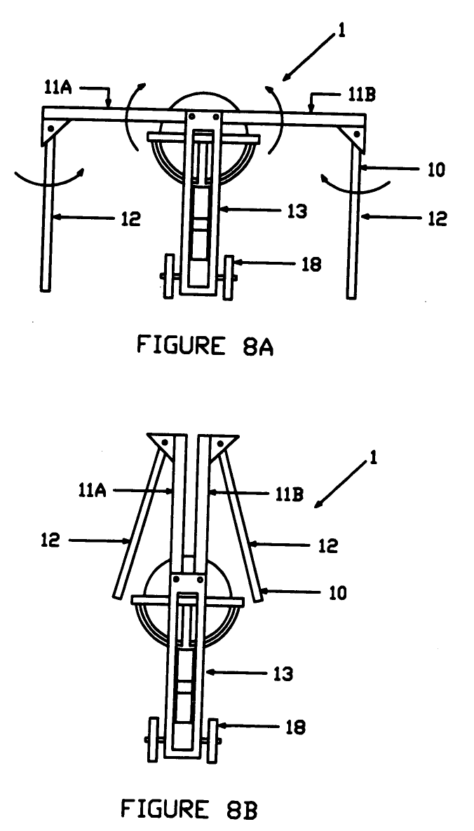

As may be seen in FIGS. 8A and 8B, the frame structure means 10 may have a collapseable feature which make the apparatus easier to store and transport. User support member 11 may be composed of two separate components 11A and 11B, each of which may be pivotaly mounted to main support members 13 so that they may be pivoted in the upward direction. Also, side support members 12 may be pivotally mounted to user support members 11A and 11B so that they may be folded inward, towards the underside of user support members 11A and 11B. User support members 11A and 11B may be secured in the upward position, while side support members 12 may be secured in their inward position, through some type of securing means such as a chord, rope, or tie. Alternately, a type of lock and release mechanism, which is commonly found in folding tables, may be utilized. The ability to collapse the apparatus greatly reduces the amount of horizontal space the apparatus encompasses while being stored or tranported. Also, wheel elements 18 may be attached to main support members 13 to also make storage and transport easier.

Many variations of the roller therapy apparatus exist, along with the configurations described above. While it will be apparent that the preferred embodiment of the invention herein disclosed is well calculated to fulfill the objects above stated, it will be appreciated that the invention is susceptible to modification, variation, and change without departing from the proper scope or fair meaning of the subjoined claims.

I claim:

1. A roller therapy apparatus comprising:
a frame structure means comprising a base frame structure with a user support member mounted thereon, said user support member having an opening;
a roller engagement means;
a roller structure means for rotatably supporting said roller engagement mean; said roller structure means mounted to said base frame structure of said frame structure means such that at least a portion of said roller engagement means extends through said opening and above the surface of said user support member of said frame structure means;
whereby a user may position themselves upon said user support member of said frame structure means and engage with different body muscle groups the portion of said roller engagement means which extends above the surface of said user support member.

2. The roller therapy apparatus as claimed in claim 1, said roller engagement means comprising a spherical roller element which is spherical in shape and has a smooth surface.

3. The roller therapy apparatus as claimed in claim 2, said base frame structure of said frame structure means further comprising side support members located along the side of said user support means; main support members located along the front and rear of said user support means; cross support members rigidly connecting the front and rear main support members, and a frame attachment member supported by said cross support members and having an opening means.

4. The roller therapy apparatus as claimed in claim 3, said user support member of said frame structure means having a relatively horizontal surface with said opening located in its general center.

5. The roller therapy apparatus as claimed in claim 4, said roller structure means comprising a generally upright base roller structure with a roller support structure rigidly mounted at its upper end, said roller support structures sized to rotatably receive and support said spherical roller element of said roller engagement mean; said base roller structure having an opening means.

6. The roller therapy apparatus as claimed in claim 5, said opening means of said frame attachment member of said base structure of said frame attachment means and said opening means of said base roller structure of said roller structure means being capable of aligment such that a bolt or pin may be place through each to secure said frame attachment member and said base roller structure to one another.

7. The roller therapy apparatus as claimed in claim 6, said base roller structure having several opening means located at various positions along its length such that the base roller structure of said roller structure means may be secured at different elevations to said frame attachment member, whereby at least a portion of said spherical roller element of said roller engagement means may be extended and secured at different elevations above the top surface of said user support member of said frame structure means.

8. The roller therapy apparatus as claimed in claim 4, said user support member of said frame structure means having a right and left part, each part pivotally mounted at its respective end to said front and back main support members, such that each part of said user support member may be folded in an upward direction; said side support members pivotally mounted to said right and left parts of user support members, such that said side support members may be folded underneath said user support members; whereby said frame structure means may be collapseable for transport and storage purposes.

9. A roller therapy apparatus comprising:
a frame structure means comprising a base frame structure with a user support member mounted thereon, said user support member having an opening;
a roller engagement means comprising a spherical roller element which is spherical in shape;
a roller structure means comprising a generally upright base roller structure with a roller support structure rigidly mounted at its upper end, said roller support structure sized to rotatably receive and support said spherical roller element of said roller engagement means; said roller structure means mounted to said base frame structure of said frame structure means such that at least a portion of said spherical roller element of said roller engagement means extends through said opening and above the surface of said user support member of said frame structure means;
whereby a user may position themselves upon said user support member of said frame structure means and engage with different body muscle groups the portion of the spherical roller element of said roller engagement means which extends above the surface of the user support member.

10. The roller therapy apparatus as claimed in claim 9, said base frame structure of said frame structure means further comprising side support members located along the side of said user support means; main support members located along the front and rear of said user support means; cross support members rigidly connecting the front and rear main support members, and a frame attachment member supported by cross support members and having an opening means.

11. The roller therapy apparatus as claimed in claim 10, said user support member of said frame structure means having a relatively horizontal surface with said opening located in its general center.

12. The roller therapy apparatus as claimed in claim 11; said base roller structure of said roller structure means having an opening means.

13. The roller therapy apparatus as claimed in claim 12, said opening means of said frame attachment member of said base structure of said frame attachment means and said opening means of said base roller structure of said roller structure means being capable of aligment such that a bolt or pin may be place through each to secure said frame attachment member and said base roller structure to one another.

14. The roller therapy apparatus as claimed in claim 13, said base roller structure having several opening means located at various positions along its length such that the base roller structure of said roller structure means may be secured at different elevations to said frame attachment member; whereby at least a portion of said spherical roller element of said roller engagement means may be extended and secured at different elevations above the top surface of said user support member of said frame structure means.

15. The roller therapy apparatus as claimed in claim 11, said user support member of said frame structure means having a right and left part, each part pivotally mounted at its respective end to said front and back main support members, such that each part of said user support member may be folded in an upward direction; said side support members pivotally mounted to said right and left parts of said user support member, such that said side support members may be folded underneath said user support member; whereby said frame structure means may be collapseable for transport and storage purposes.

16. A roller therapy apparatus comprising:
a frame structure means comprising a base frame structure with a user support member mounted thereon, said user support member having a relatively horizontal surface with an opening located in its general center;
a roller engagement means comprising a spherical roller element which is spherical in shape;
a roller structure means comprising a generally upright base roller structure with a roller support structure rigidly mounted at its upper end, said roller support structure sized to rotatably receive and support said spherical roller element of said roller engagement means; said roller structure means mounted to said base frame structure of said frame structure means such that at least a portion of said spherical roller element of said roller engagement means extends through said opening and above the surface of said user support member of said frame structure means;
whereby a user may position themselves upon said user support member of said frame structure means and engage with different body muscle groups the portion of the spherical roller element of said roller engagement means which extends above the surface of the user support member.

17. The roller therapy apparatus as claimed in claim 16, said base frame structure of said frame structure means further comprising side support members located along the side of said user support means; main support members located along the front and rear of said user support means; cross support members rigidly connecting the front and rear main support members, and a frame attachment member supported by said cross support members and having a opening means.

18. The roller therapy apparatus as claimed in claim 17; said base roller structure of said roller structure means having an opening means.

19. The roller therapy apparatus as claimed in claim 18, said opening means of said frame attachment member of said base structure of said frame attachment means and said opening means of said base roller structure of said roller structure means being capable of aligment such that a bolt or pin may be place through each to secure said frame attachment member and said base roller structure to one another.

20. The roller therapy apparatus as claimed in claim 19, said base roller structure having several opening means located at various positions along its length such that the base roller structure of said roller structure means may be secured at different elevations to said frame attachment member, whereby at least a portion of said spherical roller element of said roller engagement means may extend at different elevations above the top surface of said user support member of said frame structure means.

21. The roller therapy apparatus as claimed in claim 17, said user support member of said frame structure means having a right and left part, each part pivotally mounted at its respective end to said front and back main support members, such that each part of said user support member may be folded in an upward direction; said side support members pivotally mounted to said right and left parts of said user support member, such that said side support members may be folded underneath said user support member; whereby said frame structure means may be collapseable for transport and storage purposes.
